(19) United States
(12) Patent Application Publication
(10) Pub. No.: US 2013/0190097 A1
(43) Pub. Date: Jul. 25, 2013

(54) Golf Training Aid

(71) Applicants: Kenneth Palmer Shealy, Hendersonville, NC (US); Vincent Rene Brochu, Spartanburg, SC (US); Kenny Yan, Asheville, NC (US)

(72) Inventors: Kenneth Palmer Shealy, Hendersonville, NC (US); Vincent Rene Brochu, Spartanburg, SC (US); Kenny Yan, Asheville, NC (US)

(73) Assignee: Magic Palmer Inc., Asheville, NC (US)

(21) Appl. No.: 13/354,062

(22) Filed: Jan. 19, 2012

(51) Int. Cl. A63B 69/36; B29C 43/02

(52) U.S. Cl. 473/206; 473/409; 264/319

(57) ABSTRACT

A golf training aid comprises a body including a top surface and a bottom surface. The top surface comprises a club shaft groove. The bottom surface comprises an index finger groove, a middle finger groove and a separation bulge between the two index and middle finger grooves. The body comprises an elastomeric material having sufficient flexibility so the club shaft groove generally conforms to a golf club shaft and the index and middle finger grooves generally conform to the index and middle fingers of a user when the body is positioned between the user's hand and the golf club shaft with a user's hand gripping the golf club shaft.

### CROSS-REFERENCE TO OTHER APPLICATIONS

This application is related to the commonly assigned US design patent application number ______, filed 19 Jan. 2012, and also entitled Golf Training Aid.

### BACKGROUND OF THE INVENTION

Golf is a sport where the little things matter greatly. One area where this is especially true is how the golfer holds his or her hands in gripping the club greatly affects the golfer's ability to hit the ball squarely with distance and accuracy.

### BRIEF SUMMARY OF THE INVENTION

An example of a golf training aid comprises a body including a top surface, a bottom surface, a first end, a second end, a front end, and a back end. The first and second ends are on opposite sides of the body with the front and back ends being between the first and second ends and also on opposite sides of the body. The top surface comprises a club shaft groove extending from the first end to the second end. The club shaft groove is sized to accept a golf club shaft. The bottom surface comprises an index finger groove, a middle finger groove and a separation bulge. The index finger groove is sized to accept the index finger of a user and extends from the front end towards the back end. The middle finger groove is sized to accept the middle finger of a user and extends from the front and towards the back end. The separation bulge separates the index finger groove and the middle finger groove so to separate the index and middle fingers of a user. The body comprises an elastomeric material having sufficient flexibility so the club shaft groove generally conforms to a golf club shaft and the index and middle finger grooves generally conform to the index and middle fingers of a user when the body is positioned between the user's hand and the golf club shaft with a user's hand gripping the golf club shaft.

An example of a method for making golf training aid is carried out as follows. An elastomeric material is selected. A body is formed using the elastomeric material. The body comprises a top surface, a bottom surface, a first end, a second end, a front end, and a back end. The first and second ends are on opposite sides of the body. The front and back ends are between the first and second ends and also on opposite sides of the body. A club shaft groove is formed in the top surface extending from the first end to the second end. The club shaft groove is sized to accept a golf club shaft. An index finger groove, sized to accept the index finger of a user, is formed in the bottom surface. The index finger groove extends from the front end towards the back end. A middle finger groove, sized to accept the middle finger of a user, is formed in the bottom surface. The middle finger groove extends from the front end towards the back end. A separation bulge, separating the index finger groove and the middle finger groove, is formed in the bottom surface so to separate the index and middle fingers of a user. The elastomeric material is selected so that the body has sufficient flexibility so the club shaft groove generally conforms to a golf club shaft and so the index and middle finger grooves generally conform to the index and middle fingers of a user when the body is positioned between the user's hand and the golf club shaft with a user's hand gripping the golf club shaft.

An example of a method for using a golf training aid is carried out as follows. A golf training aid, comprising a body having a club shaft groove in a top surface of the body extending in a first direction, and index and middle finger grooves formed in a bottom surface of the body extending generally in a second direction, the selected. The second direction is generally perpendicular to the first direction. The body also has a separation bulge at the bottom surface separating the index finger groove and the middle finger groove. The bottom surface of the body is placed in the palm of the users hand with the user's index and middle fingers positioned within the index and middle finger grooves, and with the separation bulge separating the index and middle fingers. The shaft of a golf club is placed into the club shaft groove. The golf club shaft is gripped with the body captured between the user's hand and the golf club shaft so that the user's index finger spaced apart from and at an angle to the user's middle finger and the user's index finger elevated above the golf club shaft more than the user's middle finger.

Other features, aspects and advantages of the present invention can be seen on review the Figures, the detailed description, and the claims which follow.

### BRIEF DESCRIPTION OF THE DRAWINGS

FIG. 1 is a bottom plan view of one example of a golf training aid showing a separation bulge between an index finger groove and a middle finger groove, the grooves extending from the front and of the body.

FIG. 2 is a top plan view of the golf training aid of FIG. 1 showing a golf shaft groove extending between the first and second ends of the body and also showing the separation bulge between the index finger groove and the middle finger groove.

FIG. 3 is a bottom, left, front view of the golf training aid of FIG. 1.

FIG. 4 is a cross-sectional view taken along line 4-4 of FIG. 1 showing the club shaft groove in the top surface as well as portions of the separation bulge between the index finger groove and the middle finger groove.

FIGS. 5-7 are further cross-sectional view taken along lines 5-5, 6-6 and 7-7 of FIG. 1 illustrating the contour of the bottom and top surfaces of the body along those cutting plane lines.

FIG. 8 shows the training aid of FIG. 2 rotated 180° and resting in the palm of a user's hand.

FIG. 9 shows placement of a golf club shaft into the golf club shaft groove of the training aid of FIG. 8.

FIG. 10 shows the user beginning to grip the golf club shaft with the training aid between the user's hand and the golf club shaft.

FIGS. 11 and 12 are two views showing a user gripping the golf club shaft with the training aid in place.

FIG. 13 shows the angle of the user's index finger relative to the shaft to the use of the training aid.

FIG. 14 is a simplified isometric view of an alternative embodiment of the training aid of FIG. 1.

### DETAILED DESCRIPTION OF THE INVENTION

The following description will typically be with reference to specific structural embodiments and methods. It is to be understood that there is no intention to limit the invention to the specifically disclosed embodiments and methods but that the invention may be practiced using other features, elements, methods and embodiments. Preferred embodiments are described to illustrate the present invention, not to limit its scope, which is defined by the claims. Those of ordinary skill in the art will recognize a variety of equivalent variations on the description that follows. Like elements in various embodiments are commonly referred to with like reference numerals.

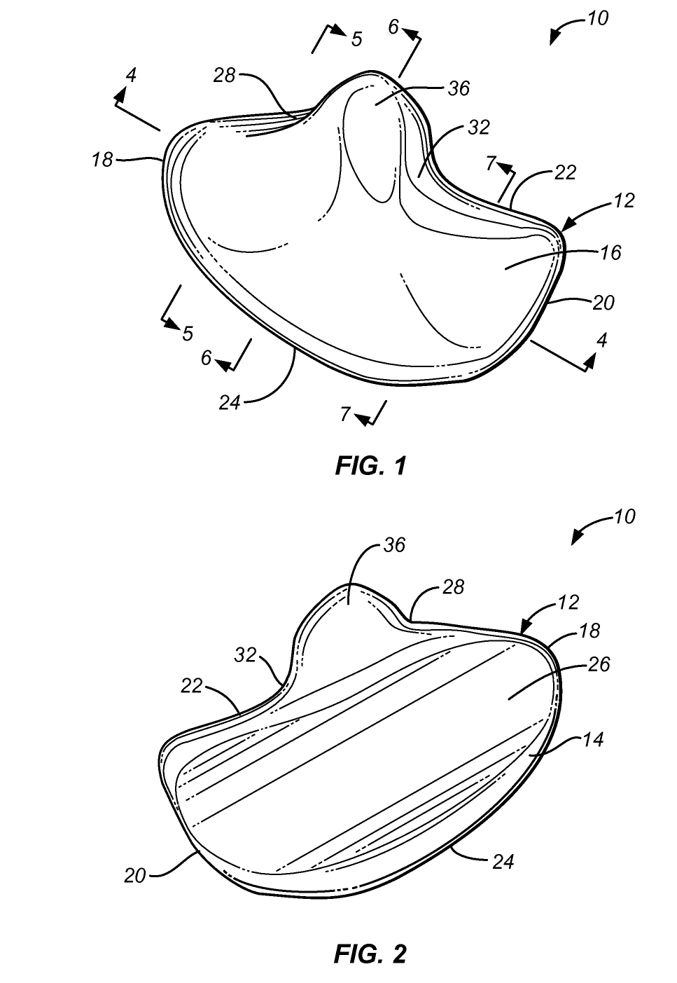

FIGS. 1-7 illustrate a golf training aid 10 comprising a body 12. Golf training aid 10 is a handheld device used to place the user's hands in a correct hitting position. In watching professional golfers and teachers, it has been observed that proper placement of the hands on the grip of the club handle is critical. Putting the user's hands in the best hitting position is believed to be a key to proper ball striking Golf training aid 10 puts the user's hands in the proper hitting position and also regulates grip pressure to allow the user to have the best possible chance at consistent contact with the ball. Golf training aid 10 provides the user with the sensation and feel of hitting the ball solidly time and time again. Golf training aid 10 can be used on practice facilities and also on the golf course and, with use, provides the user with the muscle memory for the desired hand placement. Golf training aid 10 therefore educates the user often without the need for a teaching pro.

Generally speaking, and as described in more detail below, golf training aid 10 positions the index finger of the bottom, trailing hand up and somewhat spaced apart from the middle finger, for better tip control. Tip control can be defined as the consistency of correct alignment and level of accuracy with the tip of the golf club throughout the golf swing. In some examples, golf training aid 10 also aligns the user's hands at an angle of about 5-30 degrees to the shaft. With the user's hands so positioned, the user's hands are in an improved, square striking position which allows for better golf shots, especially in and around putting greens.

Body 12 is typically made of an elastomeric material, such silicone and PVC, including food grade PVC, which will, as discussed below, generally conform to opposed surfaces during use while substantially retaining its basic shape but also return to its original shape upon release. Body 12 has a top surface 14, shown in FIG. 2 and a bottom surface 16, shown in FIG. 1. Top and bottom surfaces 14, 16 are connected by a first end 18, a second end 20, a front end 22, and a back end 24. First end 18 and a second end 20 are considered the right side and left side ends respectively. As shown, the first and second ends 18, 20 are on opposite sides of body 12. The front and back ends 22, 24 are between the first and second ends 18, 20 and are also on opposite sides of the body.

Top surface 14 defines a club shaft groove 26 extending from the first end 18 to the second end 20. Club shaft groove 26 is sized to accept a golf club shaft as shown in FIGS. 8-10. In this example, club shaft groove 26 defines a generally semi-cylindrical surface which defined a circular arc of somewhat less than 180°.

Bottom surface 16 has an index finger groove 28 formed therein. Index finger groove 28 extends from the front end 22 towards the back end 24 and is sized to accept the index finger 30 of a user as shown in FIGS. 8-13. Bottom surface 16 also has a middle finger groove 32 formed therein. Middle finger groove also extends from the front end 22 towards the back end 24 and is sized to accept the middle finger 34 of a user. A separation bulge 36 in bottom surface 16 separates the index finger groove 28 and the middle finger groove 32 so to separate the index and middle fingers 30, 34 of a user during use. While index and middle finger grooves 28, 32 extend generally parallel to one another, they are preferably at a small angle to one another, such as about 20°. The orientation of index and middle finger grooves 28, 32 together with the separation bulge 36 combine to orient index finger 30 at an angle of, in this example, about 20° to middle finger 34 and somewhat elevated relative to middle finger 34 as shown in FIGS. 8-10.

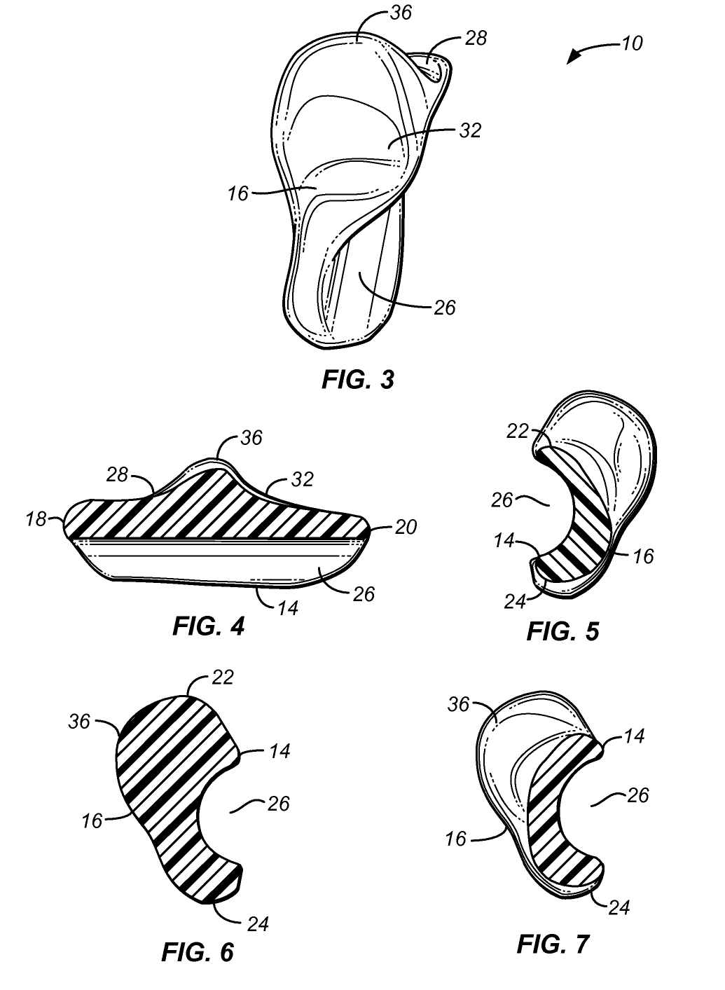

Body 12 is made of an elastomeric material having sufficient flexibility so the club shaft groove 26 generally conforms to a golf club shaft 38 and the index and middle finger grooves 28, 32 generally conform to the index and middle fingers 30, 34 of a user when body 12 is positioned between the user's hand 40 and the golf club shaft 38 with a user's hand gripping the golf club shaft. The size of body 12 can be changed to suit different players, with hand size being a major factor. A typical range in sizes between the first and second ends 18, 20 as measured in a horizontal direction in FIG. 1 is 5-7.5 cm (2-3 inches). A typical range in maximum thickness between top surface 14 and a bottom surface 16 as measured in a vertical direction in FIG. 3 is 2-3.3 cm (0.8-1.3 inches).

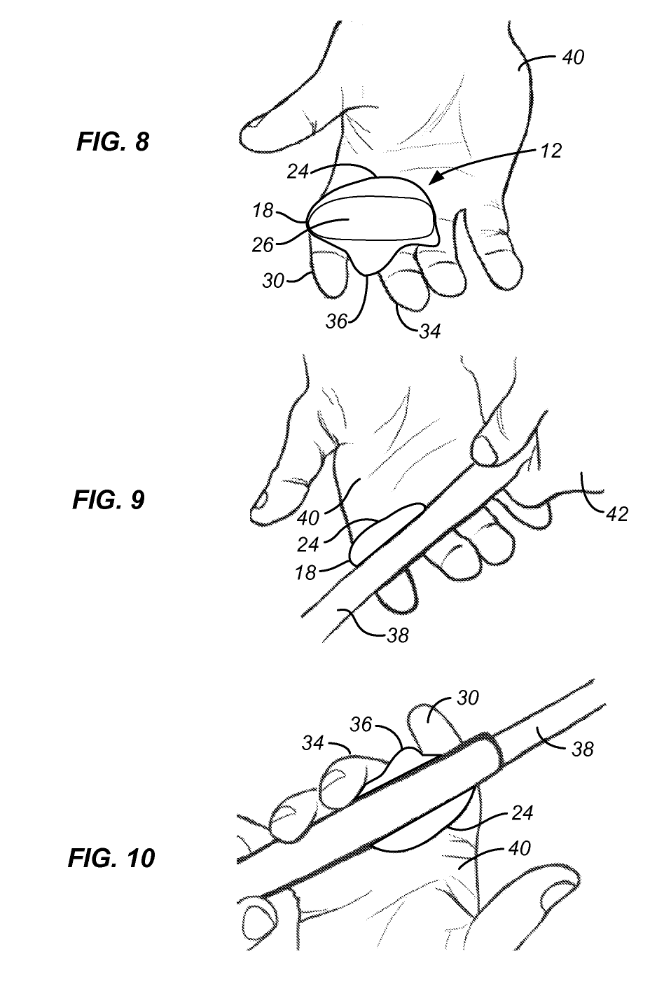

Turning now to FIGS. 8-13, the use of the golf swing training aid 10 will be described. FIG. 8 shows the placement of body 12 in the palm on the user's hand 40 with bottom surface 16 facing downwardly and touching the user's hand. Index finger 30 and middle finger 34 are positioned within index finger groove 28 and middle finger groove 32 respectively with separation bulge 36 separating the index and middle fingers 30, 34. With the user's hand 40 maintaining the generally palm up orientation of FIG. 8, the user grasps the shaft 38 of a golf club so that the shaft 38 lies within club shaft groove 26 as shown in FIG. 9. Hand 40 will act as the bottom, trailing hand. The illustrations are based on the grip of a typical right-handed golfer with the golfer's right-hand, being the dominant hand, acting as a bottom, trailing hand. However some left-handed golfers use the same type of grip as right-handed golfers with their dominant hand, their left hand, being the upper, leading hand. A mirror image of training aid 10 can be used for a typical left-handed golfer grip with the dominant, left-hand being the bottom, trailing hand.

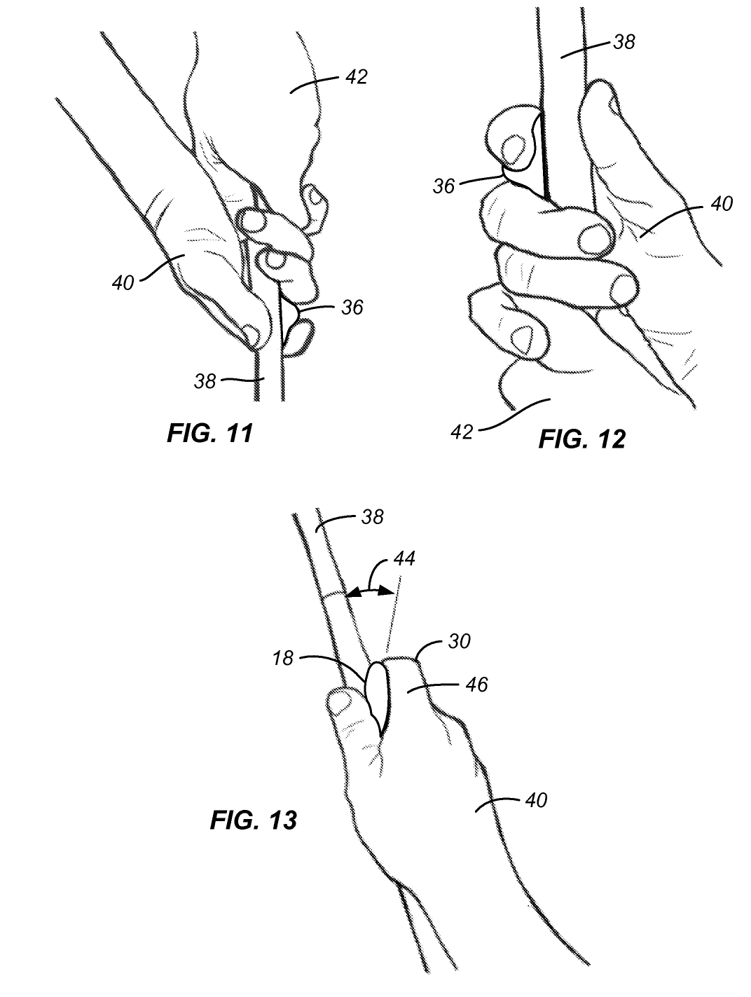

FIGS. 10 and 11 show the user forming a conventional grip with the little finger on trailing hand 40 place between the middle and index finger on the leading hand 42. Grips other than the one shown can also be used with training aid 10. Using a light to moderate gripping pressure, golf swing training aid 10 causes a moderate repositioning of middle fingers 34 and a significant repositioning of index finger 30. Training aid 10 elevates index finger 30 a distance above shaft 38 for increased tip control. Training aid 10 also separates index finger 30 from middle finger 34; this gives the user more tip control. Training aid 10 also reorients bottom, trailing hand 40 so that the angle 44 of the proximal phalanges 46 of index finger 30, see FIG. 12, relative to shaft 38 is about 5-30°. The specific angle 44 depends primarily on the size of hand 40 of the user and the size of training aid 10. The advantage of this 5-30° reorientation is that it enables the user to drive squarely through the ball.

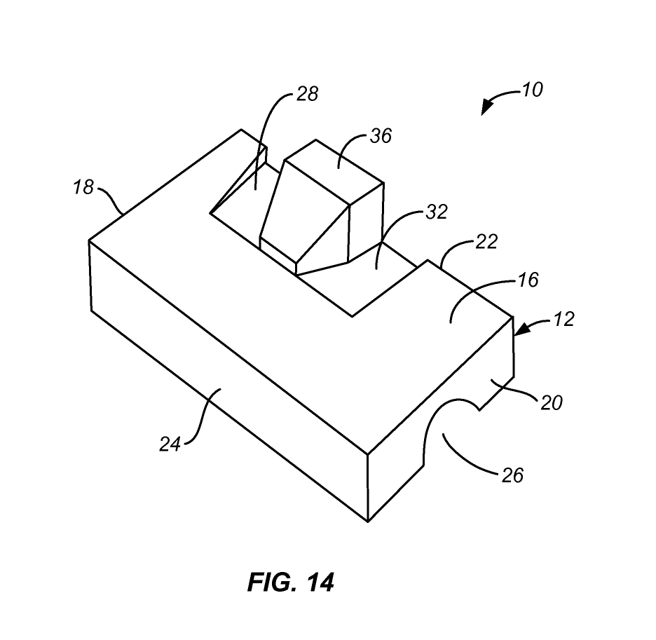

The surfaces of body 12 of the training aid of FIGS. 1- 13 are smoothly curving with rounded corners. FIG. 14 illustrates a simplified view of a further example of a training aid 10 in which substantially all the surfaces of body 12 are flat surfaces joined together at relatively abrupt corners.

One example of a method for making golf training aid 10 is carried out as follows. An elastomeric material, such as silicone or PVC, is selected. The body 12 of golf training aid 10 is formed using the elastomeric material. The body forming step includes the following. The club shaft groove 26 is formed in the top surface 14 so that it extends from the first end 18 to the second end 20. The club shaft groove 26 is size to accept a golf club shaft 38. An index finger groove 26, sized to accept the index finger 30 of a user, is formed in the bottom surface 16. The index finger groove 26 extends from the front end 22 towards the back end 24, typically about halfway towards the back end. A middle finger groove 32, sized to accept the middle finger 34 of a user, is formed in the bottom surface 16. The middle finger groove 32 extends from the front end 22 towards the back end 24, typically about one third of the way towards the back end. A separation bulge 36, separating the index finger groove 28 and the middle finger groove 32, is formed in the bottom surface 16 so to separate the index and middle fingers 30, 34 of a user. In some examples, the average thickness of body 12 between lower and upper surfaces 16, 14 at index finger groove 28 is somewhat greater than the average thickness at index finger groove 32 so that index finger 30 is elevated a greater distance above shaft 38 than middle finger 34 is raised above shaft 38. The elastomeric material is selected so that the body 12 has sufficient flexibility so the club shaft groove 26 generally conforms to a golf club shaft 38 and the index and middle finger grooves 28, 32 generally conform to the index and middle fingers 30, 34 of a user when the body 12 is positioned between the user's hand 40 and the golf club shaft 38 with a user's hand gripping the golf club shaft.

In use, a golf training aid 10 of an appropriate size for the particular user is selected. The golf training aid 10 includes body 12 having a club shaft groove 26 in a top surface 14 of the body extending in a first direction, index and middle finger grooves 28, 32 formed in a bottom surface 16 of the body extending generally parallel to one another in a second direction. The second direction is typically generally perpendicular to the first direction. The golf training aid 10 also includes a separation bulge 36 at the bottom surface 16 separating the index finger groove 28 and the middle finger groove 32. The bottom surface 16 of the body 12 is placed in the palm of the users hand 40 with the user's index and middle fingers 30, 34 positioned within the index and middle finger grooves 28, 32. The shaft 38 of a golf club is placed into the club shaft groove 26. The golf club shaft 38 is then gripped by the user with the body 12 captured between the user's hand 40 and the golf club shaft 38.

The above descriptions may have used terms such as above, below, top, bottom, over, under, et cetera. These terms may be used in the description and claims to aid understanding of the invention and not used in a limiting sense.

While the present invention is disclosed by reference to the preferred embodiments and examples detailed above, it is to be understood that these examples are intended in an illustrative rather than in a limiting sense. It is contemplated that modifications and combinations will occur to those skilled in the art, which modifications and combinations will be within the spirit of the invention and the scope of the following claims. For example, body 12 could be made primarily from an appropriate single elastomeric material but include other materials, such as a flexible outer surface film or other materials embedded within the elastomeric material matrix. Also, body 12 could be made from more than one elastomeric material with or without other, non-elastomeric materials long as the desired conformability and ability to return to its original shape are maintained. The desired elastomeric characteristic of body 12 can also be achieved with the body having a solid, but preferably flexible, central core covered by an elastomeric outer layer.

Any and all patents, patent applications and printed publications referred to above are incorporated by reference.

What is claimed is:

1. A golf training aid comprising:
a body comprising a top surface, a bottom surface, a first end, a second end, a front end, and a back end, the first and second ends being on opposite sides of the body, the front and back ends being between the first and second ends and also on opposite sides of the body;
the top surface comprising a club shaft groove extending from the first end to the second end, the club shaft groove sized to accept a golf club shaft;
the bottom surface comprising:
an index finger groove, sized to accept the index finger of a user, extending from the front end towards the back end;
a middle finger groove, sized to accept the middle finger of a user, extending from the front and towards the back end; and
a separation bulge separating the index finger groove and the middle finger groove so to separate the index and middle fingers of a user; and
the body comprising an elastomeric material having sufficient flexibility so the club shaft groove generally conforms to a golf club shaft and the index and middle finger grooves generally conform to the index and middle fingers of a user when the body is positioned between the user's hand and the golf club shaft with a user's hand gripping the golf club shaft.

2. The golf training aid according to claim 1, wherein the body is made of at least one of silicone and PVC.

3. The golf training aid according to claim 1, wherein the club shaft groove defines a generally semi-cylindrical surface.

4. The golf training aid according to claim 1, wherein the index finger groove extends about halfway from the front end towards the back end.

5. The golf training aid according to claim 1, wherein the middle finger groove extends about one third of the way from the front end towards the back end.

6. The golf training aid according to claim 1, wherein the average thickness of the body between the top and bottom surfaces at the index finger groove is greater than the average thickness of the body between the top and bottom surfaces at the middle finger groove.

7. The golf training aid according to claim 1, wherein the index finger groove and the middle finger groove are oriented at an angle to one another.

8. A method for making golf training aid comprising:
selecting an elastomeric material;
forming a body using the elastomeric material, the body comprising a top surface, a bottom surface, a first end, a second end, a front end, and a back end, the first and second ends being on opposite sides of the body, the front and back ends being between the first and second ends and also on opposite sides of the body, the body forming step comprising:
forming a club shaft groove in the top surface extending from the first end to the second end, the club shaft groove sized to accept a golf club shaft;
forming an index finger groove, sized to accept the index finger of a user, in the bottom surface, the index finger groove extending from the front end towards the back end;
forming a middle finger groove, sized to accept the middle finger of a user, in the bottom surface, the middle finger groove extending from the front end towards the back end; and
forming a separation bulge, separating the index finger groove and the middle finger groove, in the bottom surface so to separate the index and middle fingers of a user; and
the elastomeric material selecting step carried out so that the body has sufficient flexibility so the club shaft groove generally conforms to a golf club shaft and the index and middle finger grooves generally conform to the index and middle fingers of a user when the body is positioned between the user's hand and the golf club shaft with a user's hand gripping the golf club shaft.

9. The method according to claim 8, wherein the selecting step comprises selecting at least one of silicone and PVC.

10. The method according to claim 8, wherein the club shaft groove forming step is carried out so that the club shaft groove defines a generally semi-cylindrical surface.

11. The method according to claim 8, wherein the index finger groove forming step is carried out so that the index finger groove extends about halfway from the front end towards the back end.

12. The method according to claim 8, wherein the middle finger groove forming step is carried out so that the middle finger groove extends about one third of the way from the front end towards the back end.

13. The method according to claim 8, wherein the body forming step further comprises forming the body so that the average thickness of the body between the top and bottom surfaces at the index finger groove is greater than the average thickness of the body between the top and bottom surfaces at the middle finger groove.

14. The method according to claim 8, wherein the index and middle finger groove forming steps are carried out so that the index and middle finger grooves at an angle to one another.

15. The method according to claim 8, wherein the index and middle finger groove forming steps are carried out so that the index and middle finger grooves are at an angle of about 20° to one another.

16. A method for using a golf training aid comprising:
selecting a golf training aid comprising a body having a club shaft groove in a top surface of the body extending in a first direction, index and middle finger grooves formed in a bottom surface of the body extending generally in a second direction, the second direction being generally perpendicular to the first direction, and a separation bulge at the bottom surface separating the index finger groove and the middle finger groove;
placing the bottom surface of the body in the palm of the users hand with the user's index and middle fingers positioned within the index and middle finger grooves with the separation bulge separating the index and middle fingers;
placing a shaft of a golf club into the club shaft groove; and
gripping the golf club shaft with the body captured between the user's hand and the golf club shaft with:
the user's index finger spaced apart from and at an angle to the user's middle finger and;
the user's index finger elevated above the golf club shaft more than the user's middle finger.

17. The method according to claim 16, wherein the user's index and middle fingers are oriented at an angle of about 20° to one another.
